(19) United States
(12) Patent Application Publication
(10) Pub. No.: US 2026/0009661 A1
(43) Pub. Date: Jan. 8, 2026

(54) MEASURING STANDARD AND OPTICAL POSITION MEASURING DEVICE WITH THIS MEASURING STANDARD

(71) Applicant: DR. JOHANNES HEIDENHAIN GmbH, Traunreut (DE)

(72) Inventors: Peter SPECKBACHER, Kirchweidach (DE); Stefan FUNK, Stein a.d. Traun (DE)

(21) Appl. No.: 19/254,232

(22) Filed: Jun. 30, 2025

(30) Foreign Application Priority Data
Jul. 5, 2024 (DE) 102024002189.2

(51) Int. Cl. G01D 5/40

(52) U.S. Cl. CPC G01D 5/40

(57) ABSTRACT

A scale for an optical position measuring device includes a carrier substrate, a first reflector layer arranged on the carrier substrate, a transparent spacer layer arranged on the reflector layer, a structured second reflector layer arranged on the spacer layer, and a protection layer with a defined thickness arranged on the top side of the scale over the second reflector layer. The protection layer is further arranged on the side surfaces of the scale.

### CROSS-REFERENCE TO RELATED APPLICATIONS

The present application claims priority to Application No. 10 2024 002 189.2, filed in the Federal Republic of Germany on Jul. 5, 2024, which is expressly incorporated herein in its entirety by reference thereto.

### FIELD OF THE INVENTION

The present invention relates to a scale for an optical position measuring device and to an optical position measuring device with such a scale. Via the optical scanning of such a scale by a scanning unit, a displacement between the scale and the scanning unit or the relative position of the scale and the scanning unit can be detected.

### BACKGROUND INFORMATION

Optical position measuring devices, which are based on the optical scanning of scales, are used, for example, for high-precision position detection in semiconductor production systems, among others. For example, it is possible to precisely determine the position of the wafer table relative to the imaging optics in lithography devices with the aid of such optical position measuring devices. In the case of EUV lithography devices, position determination can be provided in regions of such devices in which high-energy electromagnetic radiation is used. Under certain circumstances, this could result in damage to components of the position measuring device, particularly in the scale used, due to the EUV radiation. Furthermore, the scale could also be damaged by the free hydrogen radicals present in such environments. These result from the interaction of the EUV radiation with the hydrogen gas present, as described in the M.v.d. Kerkhof et al., EUV-Induced Hydrogen Plasma and Particle Release, Radiation Effects & Defects in Solids, 2022, Vol. 177, Nos. 5-6, p. 486 to 512. Unwanted removal of material from the scales used would possibly result in contamination of the mirror optics in the EUV lithography device.

A scale for an optical position measuring device is described in European Patent Document No. 1 436 647, in which the reflective phase grating, illustrated in FIG. 2 thereof, includes a carrier substrate on which a first reflector layer made of aluminum, a transparent spacer layer, a structured second reflector layer made of chromium, and a protection layer arranged thereover are provided. A sol-gel protection layer or, alternatively, a spin-on-glass layer is described as a protection layer. When used in EUV lithography devices, neither the protection layer materials nor the provided protection layer configuration can reliably ensure that the scale is sufficiently resistant to hydrogen radicals and EUV radiation. In addition, these layers are usually applied using a spin coating process. The fluctuations in the thickness of the sol-gel layer or the spin-on-glass layer thus caused by the manufacturing process also impair the achievable diffraction efficiencies required for high-precision measuring systems.

### SUMMARY

Example embodiments of the present invention provide a scale, and a position measuring device equipped with such a scale, with improved stability against high-energy electromagnetic radiation.

According to an example embodiment of the present invention, a scale for an optical position measuring device includes a carrier substrate, a first reflector layer arranged on the carrier substrate, a transparent spacer layer arranged on the reflector layer, a structured second reflector layer arranged on the spacer layer, and a protection layer with a defined thickness arranged on the top side of the scale over the second reflector layer. The protection layer is further arranged on the side surfaces of the scale.

For example, the thickness of the protection layer on the side surfaces of the scale is selected to be a factor of 5 to 10 less than the thickness of the protection layer on the top side of the scale.

It is possible that, the thickness of the protection layer on the side surfaces of the scale is 30 nm±10%, and the thickness of the protection layer on the top side of the scale is 210 nm±2%, or the thickness of the protection layer on the side surfaces of the scale is 60 nm±10% and the thickness of the protection layer on the top side of the scale is 420 nm±2%.

It may be provided that the protection layer is made of a material that prevents removal of material in the carrier substrate and/or in the reflector layers and/or in the spacer layer caused by hydrogen radicals.

The protection layer may be made of one of the following materials: titanium oxide (TiOₓ, in which x=2 to 4); ruthenium oxide (RuO₂); chromium oxide (Cr₂O₃); vanadium oxide (V₂O₅); and niobium oxide (Nb₂O₅).

According to example embodiments, the first reflector layer is made of aluminum, the spacer layer is made of silicon oxide or titanium oxide, and the second reflector layer is made of chromium.

It may also be provided that the first reflector layer has a layer thickness in the range of 20 nm to 120 nm, the spacer layer has a layer thickness in the range of 130 nm to 170 nm, and the second reflector layer has a layer thickness in the range of 20 nm to 50 nm.

For example, the exposed underside of the carrier substrate is not covered with the protection layer.

An optical position measuring device has a scale as described herein as well as a scanning unit movable relative thereto, in which the scanning unit is configured for optical scanning of the scale with light of a defined wavelength.

The scanning unit may include a light source that emits light with a wavelength of 976 nm.

The thickness of the protection layer on the top side of the scale may be selected such that the intensity of the beam bundles diffracted by the scale to the ±1st order is at least 25% of the intensity of the incident beam bundles.

It may be provided that the thickness (d_{OS}) of the protection layer on the top side of the scale with perpendicular incidence of light satisfies the following relationship:

$${d}_{OS} = m \cdot ( λ / 2 n ) \pm 2 \% ,$$

in which d_{OS} represents the thickness of the protection layer on the top side of the scale, m=1, 2, 3, or 4, λ represents the wavelength of the light used for scanning, and n represents the refractive index of the protection layer.

An advantage of the scale described herein is efficient protection against EUV radiation and hydrogen radicals. Damage to or degradation of layers of the scale structure can be reliably avoided. Furthermore, it is ensured that even in such environments, there is no removal of material from the scale that could affect sensitive other components, such as the mirrors in EUV lithography devices. Additionally, a high diffraction efficiency of the scale is ensured, i.e., the optical scanning for generating high-precision position-dependent scanning signals is not impaired by the measures described herein.

If titanium oxide TiO₂ is used as a protection layer material, it may be applied using a sputtering method. This method makes it possible to coat the top side and side surfaces of the scale in a single work step. Furthermore, the sputtering process allows the thickness of the protection layer to be set extremely precisely, which is approximately ±3% in the range of the target protection layer thicknesses.

Further features and aspects of example embodiments of the present invention are described in more detail below with reference to the appended schematic Figures.

### BRIEF DESCRIPTION OF THE DRAWINGS

FIG. 1a is a schematic cross-sectional view of an optical position measuring device with a scale.

FIG. 1b is a schematic cross-sectional view an optical position measuring device with a scale.

FIG. 2 graphically illustrates a simulation of the dependence of the diffraction efficiency on the protection layer thickness of the scale.

### DETAILED DESCRIPTION

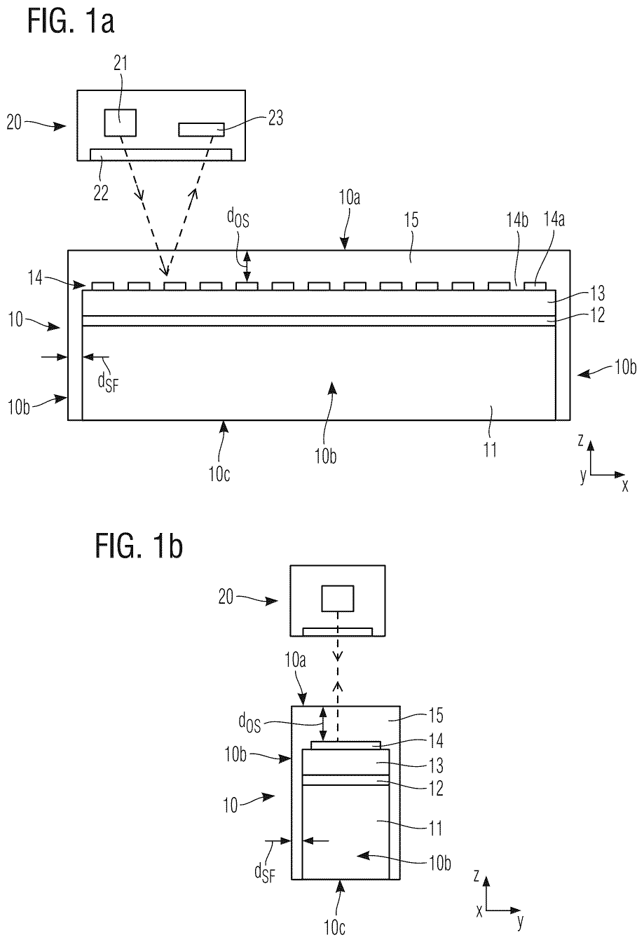

An optical position measuring device in which a scale is used is explained below with reference to the cross-sectional views of FIGS. 1a and 1b.

In the illustrated example embodiment, the position measuring device is arranged as a length measuring system and includes a scanning unit 20 in addition to the scale 10. The scale 10 and the scanning unit 20 are movable relative to each other along the measuring direction x. For example, machine components can be connected to the scale 10 and the scanning unit 20, which machine components are movable relative to each other along the measuring direction x and whose relative position may be detected with the aid of the position measuring device. Position-dependent scanning signals generated by the position measuring device are used by a control unit to control the movement of the machine components.

The scale, described in more detail below, is usable in position measuring devices other than those used in length measuring systems. For example, it is also possible to use scales for rotary position measuring devices that detect a rotational movement of two objects movable in relation to each other about an axis of rotation. Likewise, two- or multi-dimensional position measuring devices may also be equipped with scales as described herein, which provide for position measurement along multiple linear and/or rotational measuring directions, etc.

For optical scanning of the scale 10 and for generating the scanning signals, the scanning unit 20 includes a light source 21 that emits light of a defined wavelength A. For example, a light source 21 is used that emits light with a wavelength λ=976 nm. The beam bundles generated by the light source 21 first pass through a scanning grid 22 in the scanning unit 20, then impinge on the scale 10, and then pass through the scanning grid 22 a second time before striking a detector arrangement 23 in the scanning unit 20. A highly schematic and simplified scanning beam path is illustrated in the Figures. A wide variety of optical scanning principles may be used. Details of a suitable optical scanning principle are described, for example, in European Patent Document No. 1 762 828 and U.S. Patent Application Publication No. 2007/0058173, each of which is expressly incorporated herein in its entirety by reference thereto.

The scanned scale 10 has a carrier substrate 11, which is, for example, made of a material with a particularly low coefficient of thermal expansion. A glass ceramic, for example, which is available under the name Zerodur, is suitable for this purpose. However, other materials with a low coefficient of thermal expansion may also be used for the carrier substrate 11, e.g., the glass ceramic Clearceram, borofloat glass, or quartz glass. A thickness of the carrier substrate 11 is in the range of 5 mm to 20 mm.

A first reflector layer 12 is arranged or applied on the carrier substrate 11. For example, a full-surface coating of the carrier substrate 11 with the first reflector layer 12 is provided. Aluminum is a suitable material for the first reflector layer 12, which is vapor-deposited with a layer thickness in the range of 20 nm to 120 nm.

A transparent spacer layer 13 is arranged over or on the first reflector layer 12, in which, as illustrated in FIGS. 1a and 1b, a full-surface arrangement of the spacer layer 13 on the first reflector layer 12 is provided in the illustrated example embodiment. As material of the spacer layer 13, silicon oxide (SiOₓ) with a refractive index n=1.46 is provided, which is applied in a layer thickness in the range of 120 nm to 170 nm. Titanium oxide (TiOₓ) may also be used as an alternative material for the spacer layer.

A structured second reflector layer 14 is arranged over the spacer layer 13. This includes, or consists of, partial regions 14a, 14b of different optical transmittance arranged alternately in measuring direction x, in which opaque partial regions 14a made of chromium and completely transmissive partial regions 14b are provided in the present example. The partial regions 14a, 14b form the measuring graduation of the scale 10 and, in the case of an incremental measuring graduation, include, or consist of, line-shaped partial regions 14a, 14b arranged periodically along the measuring direction x, whose longitudinal direction of extension is oriented perpendicular to the measuring direction x, i.e., along the y-direction indicated in the Figures. To produce the structured second reflector layer 14, the material of the opaque partial regions 14a, i.e., chromium, is first deposited over the entire surface and is then removed again in the transmissive partial regions 14b using a suitable lithography process. The layer thickness of the second reflector layer 14 is selected to be in the range of 20 nm to 50 nm, for example.

A protection layer 15 is applied over the second reflector layer 14 on the top side 10a of the scale. Furthermore, the protection layer 15 is also arranged on the side surfaces 10b of the scale. The top side 10a of the scale is the side of the scale 10 facing the scanning unit or the side with the second structured reflector layer 14. On the scale 10, only the exposed underside 10c of the carrier substrate 11 is not covered with the protection layer 15. Via the underside 10c, the scale 10 is mounted on a carrier via a suitable fastening method or technique, such as bonding or optical bonding, which carrier in turn is arranged on a machine component.

In this manner, the part of the scale 10 that is exposed to the respective measuring environment, i.e., the top side 10a of the scale and the side surfaces 10b of the scale, is reliably protected against external influences such as high-energy radiation and/or hydrogen radicals. The underside 10c of the carrier substrate 11, which is not covered with the protection layer 15, is not normally exposed to these influences due to the aforementioned mounting on a carrier and thus does not require any further protective measures.

A suitable material for the protection layer 15 is titanium oxide TiOₓ, in which x=2−4. Other generally suitable materials for the protection layer are, for example, ruthenium oxide (RuO₂), chromium oxide (Cr₂O₃), vanadium oxide (V₂O₅), or niobium oxide (Nb₂O₅). In general, the protection layer 15 should be made of a material that prevents removal of material in the carrier substrate 11 and/or in the reflector layers 12, 14 and/or in the spacer layer 13 caused by hydrogen radicals.

The respective protection layer material is, for example, applied to the top side 10a and the side surfaces 10b of the scale using a sputtering method. For example, in a sputtering system, the scale 10 is placed flat with the second structured reflector layer 14 opposite the sputtering target. This prevents the underside 10c of the carrier substrate 11 from also being unintentionally coated with the protection layer material. On the other hand, such an arrangement results in a directional (e.g., isotropic) coating of the top side 10a of the scale and a non-directional (e.g., anisotropic) coating of the side surfaces 10b of the scale. By appropriately selecting the sputtering parameters, different deposition rates of the protection layer material on the top side 10a and the side surfaces 10b of the scale can be set in this manner, providing respectively, different thicknesses d_{OS}, d_{SF} of the protection layer 15 on the top side 10a and the side surfaces 10b of the scale. For example, this is done such that the thickness d_{SF} of the protection layer 15 on the side surfaces of the scale is smaller by a factor of 5 to 10 than the thickness d_{OS} of the protection layer on the top side 10a of the scale. It should be noted that the representation of the protection layer thicknesses d_{SF}, d_{OS} in FIGS. 1a, 1b is not shown to scale in accordance with the above dimensional relationship, but is only illustrated in a highly schematic form.

When dimensioning the thickness of the protection layer d_{OS} on the top side 10a of the scale, i.e., above the second structured reflector layer 14, it must be ensured that the intensity of the beam bundles diffracted by the scale 10 to the ±1st order is only impaired to the extent that it is at least 25% of the intensity of the incident beam bundles. Otherwise the optical scanning of the scale 10 and thus the generation of the high-precision position-dependent scanning signals would be negatively affected. The thickness dimensioning in the scale is thus carried out such that the thickness d_{OS} of the protection layer 15 on the top side 10a of the scale with perpendicular incidence of the light is selected according to the following relationship:

$${d}_{OS} = m \cdot ( λ / 2 n ) \pm 2 \%$$

in which d_{OS} represents the thickness of the protection layer on the top side of the scale, m: =1, 2, 3, or 4, λ represents the wavelength of the light used for scanning, and n represents the refractive index of the protection layer 15.

By selecting the layer thickness d_{OS} on the top side 10a of the scale in accordance with the above relationship, it is ensured that the phase grating effect of the scale 10 required for optical scanning is not or only slightly disturbed.

The selection of the parameter m in the specified range 1 to 4 is considered to be advantageous, since, with larger values for m and thus even greater thicknesses d_{OS} of the protection layer 15 on the top side 10a of the scale, the scattering of the reflected partial beam bundles at defects in the protection layer 15 would increase. Such defects scatter the light used for scanning and can thus reduce the required accuracy of the position measuring device. Furthermore, in the case of too large layer thickness d_{OS} in the range d_{OS}>1 μm, the protection layer 15 could also flake off if tensions between the protection layer 15 and the other scale materials can no longer be relaxed.

If a wavelength of λ=976 nm is used, the layer thicknesses d_{OS}=210 nm±2% (m=1) and d_{OS}=420 nm±2% (m=2) on the top side 10a of the scale are suitable dimensioning parameters for m=1 or m=2 and the use of the protection layer material titanium oxide with a refractive index n=2.3. According to the dimensioning relationship mentioned above for the thicknesses d_{SF} of the protection layer 15 on the side surfaces 10b of the scale, the thickness d_{SF} of the protection layer 15 on the side surfaces 10b of the scale may be selected as d_{SF}=30 nm±10% (m=1) or, respectively, d_{SF}=60 nm±10% (m=2).

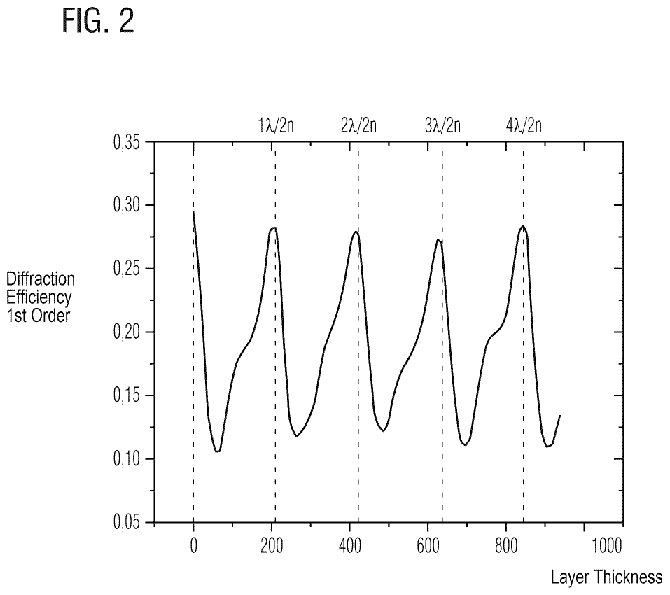

FIG. 2 illustrates a simulation of the resulting diffraction efficiency±1st order of a scale, as described herein, as a function of the layer thickness d_{OS} on the top side of the scale, in which the scale is illuminated with light of wavelength λ=976 nm polarized perpendicular to the line-shaped partial regions of the measuring graduation. For the parameters m=1 and m=2, the layer thicknesses d_{OS}=210 nm (m=1) and d_{OS}=420 nm (m=2) provide a sufficient diffraction efficiency in the range of more than 25%, taking into account the above-mentioned tolerances for d_{OS}. This behavior applies analogously to radiation polarized parallel to the line-shaped partial regions of the measuring graduation with a wavelength λ=976 nm.

What is claimed is:

1. A scale for an optical position measuring, comprising:
a carrier substrate;
a first reflector layer arranged on the carrier substrate;
a transparent spacer layer arranged on the first reflector layer;
a structured second reflector layer arranged on the spacer layer having partial regions of different optical transmittance;
a protection layer having a defined thickness arranged on a top side of the scale over the second reflector layer and arranged on side surfaces of the scale.

2. The scale according to claim 1, wherein a thickness of the protection layer on the side surfaces of the scale is smaller by a factor of 5 to 10 than a thickness of the protection layer on the top side 10a of the scale.

3. The scale according to claim 2, wherein (a) the thickness of the protection layer on the side surfaces of the scale is 30 nm±10%, and the thickness of the protection layer on the top side of the scale is 210 nm±2%, or (b) the thickness of the protection layer on the side surfaces of the scale is 60 nm±10%, and the thickness of the protection layer on the top side of the scale is 420 nm±2%.

4. The scale according to claim 1, wherein the protection layer is made of a material that prevents removal of material in the carrier substrate, in the reflector layers, and/or in the spacer layer caused by hydrogen radicals.

5. The scale according to claim 1, wherein the protection layer is made of one of the following materials: titanium oxide (TiOₓ, in which x=2 to 4), ruthenium oxide (RuO₂), chromium oxide (Cr₂O₃), vanadium oxide (V₂O₅), or niobium oxide (Nb₂O₅).

6. The scale according to claim 1, wherein the first reflector layer is made of aluminum, the spacer layer is made of silicon oxide or titanium oxide, and the second reflector layer is made of chromium.

7. The scale according to claim 1, wherein the first reflector layer has a layer thickness in the range of 20 nm to 120 nm, the spacer layer has a layer thickness in the range of 130 nm to 170 nm, and the second reflector layer has a layer thickness in the range of 20 nm to 50 nm.

8. The scale according to claim 1, wherein an exposed underside of the carrier substrate is not covered with the protection layer.

9. The scale according to claim 1, wherein the structured second reflection layer include opaque partial regions and transmissive partial regions.

10. The scale according to claim 1, wherein the structured second reflection layer has a thickness in the range of 20 nm to 50 nm.

11. An optical position measuring device, comprising:
the scale as recited in claim 1; and
a scanning unit movable relative to the scale and adapted to optically scan the scale with light having a predefined wavelength.

12. The optical position measuring device according to claim 11, wherein the scanning unit includes a light source adapted to emit light with a wavelength of 976 nm.

13. The optical position measuring device according to claim 11, wherein the thickness of the protection layer on the top side of the scale is adapted to provide that an intensity of beam bundles diffracted by the scale to a ±1st order is at least 25% of an intensity of incident beam bundles.

14. The optical position measuring device according to claim 11, wherein the thickness of the protection layer on the top side of the scale with perpendicular incidence of light satisfies the following relationship:
$${d}_{OS} = m \cdot ( λ / 2 n ) \pm 2 \%$$
in which d_{OS} represents the thickness of the protection layer on the top side of the scale, m=1, 2, 3, 4, λ represents wavelength of the light used for scanning, and n represents a refractive index of the protection layer.

15. The optical position measuring device according to claim 11, wherein the wavelength is 976 nm.
